(19) United States
(12) Patent Application Publication
(10) Pub. No.: US 2005/0015208 A1
(43) Pub. Date: Jan. 20, 2005

(54) Multi machine inspection system

(76) Inventor: William J. Furnas, Elmira, NY (US)

Correspondence Address: Spencer T. Smith;Emhart Glass Research, Inc., 89 Phoenix Avenue, P.O. Box 1229, Enfield, CT, 06083-1229, US

(21) Appl. No.: 10/622,761

(22) Filed: Jul. 18, 2003

(51) Int. Cl. G06F 19/00; G01B 5/28; G01B 5/30

(52) U.S. Cl. 702/35

(57) ABSTRACT

An inspection system includes a number of inspection machines arranged in a row which sequentially inspect a bottle as it is conveyed through the machines. Each machine determines whether the bottle should be rejected as a result of each inspection and passes inspection data for that bottle in an Ethernet packet via an Ethernet cable connection to the processor of the next machine. The processor in the last downstream machine accordingly functions as a supervisory computer to all the machines.

The present invention relates to machines, which inspect bottles for defects and more particularly to a system, which includes a number of such machines collectively evaluating a bottle.

### BACKGROUND OF THE INVENTION

Machines for inspecting glass bottles conduct a great variety of inspections including an inspection for the mold cavity data so that an operator will know where a defective bottle was made and can promptly adjust the bottle making process to eliminate the problem at that mold. Conventionally a single machine can only handle a limited number of inspections and as a result a number of machines will sequentially receive the bottle to be inspected and together all the required inspections will be completed.

Each machine has its own inspection system, which will determine whether any processed bottle has passed or failed each of the inspections conducted by the machine. Conventionally, a machine's data is transmitted to a supervisory computer, which receives similar data from the other machines and combines the data for subsequent use.

### OBJECT OF THE INVENTION

It is an object of the present invention to provide a system for inspecting glass containers, which is defined by a number of machines which eliminates the requirement of a supervisory computer.

Other objects and advantages of the present invention will become apparent from the following portion of this specification and from the accompanying drawings which illustrate, in accordance with the mandate of the patent statutes, a presently preferred embodiment incorporating the principles of the invention.

### BRIEF DESCRIPTION OF THE DRAWINGS

FIG. 1 is an elevational schematic view of a system for inspecting bottles; and

FIG. 2 is a logic diagram for the processor of each of the machines shown in FIG. 1.

### BRIEF DESCRIPTION OF THE PREFERRED EMBODIMENT

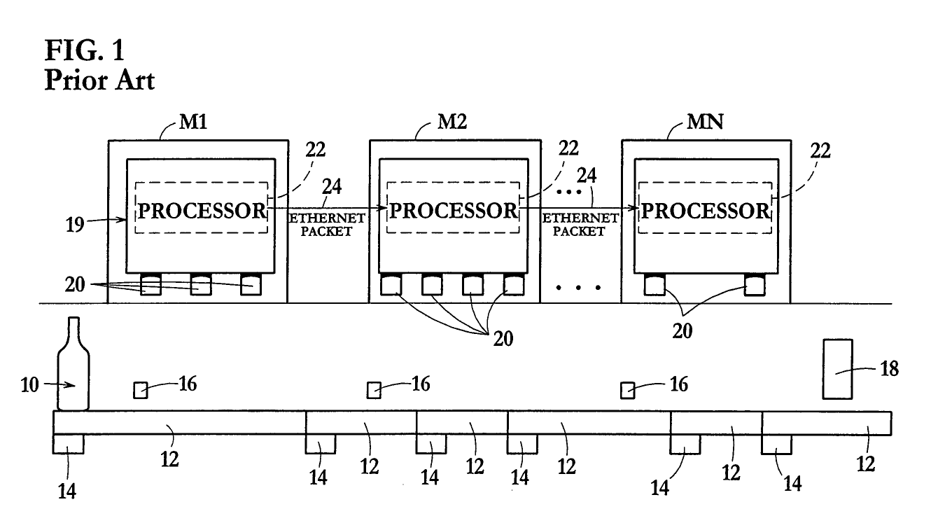

FIG. 1 shows a number of inspection machines M1,M2,Mn which sequentially inspect a bottle 10. The bottle is conveyed through the machines via any number of conveyors 12 which could include belt conveyors which support the bottom of a bottle or devices which have opposed pairs of belts which grip the side wall of a bottle, for example. An encoder 14 is associated with each conveyor so that the position of a bottle can be tracked through the machine. Also present at the entry of each machine is a part present sensor 16 and a rejector 18 is located following the discharge of a bottle from the last machine.

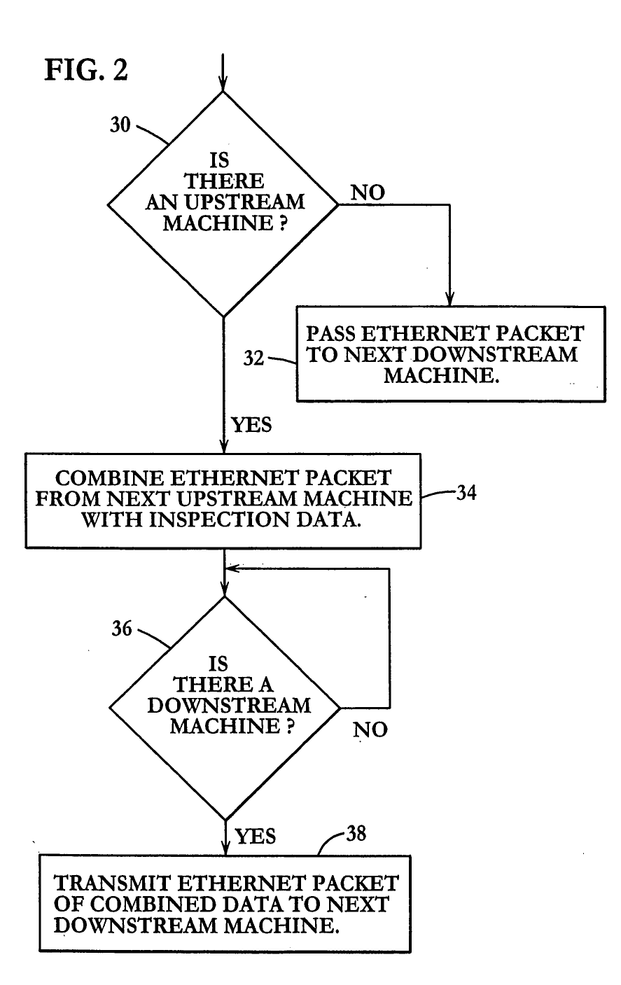

Each machine has an inspection system 19, which includes a number of inspection stations 20 (more than one inspection could be performed at a single station). The processor 22 in each inspection system will identify the bottle being inspected as the part passes the bottle present sensor and will inspect the bottle. At the completion of the inspection processes carried out by a machine, the processor will know whether or not any of the inspections carried out by that machine indicate that the bottle should be rejected. As can be seen from FIG. 1, neighboring processors are connected via an Ethernet cable 24. Referring to FIG. 2, the query “Is there an Upstream Machine” 30 will be answered in the negative for the processor in the most upstream location. Accordingly, this processor will form its data into an Ethernet Packet and Pass Ethernet Packet To Next Downstream Machine 32.

This query will be answered in the affirmative for any downstream processor and a downstream processor will Combine Ethernet Packet From Next Upstream Machine With Inspection Data 34. Where the machine is a middle machine (one that has a machine on either side) the query “Is There A Downstream Machine?” 36 will be answered in the affirmative and the processor of that machine will Transmit Ethernet Packet Of Combined Data To Next Downstream Machine 38. The combined data will be the data received via the Ethernet packet from the next upstream machine and the inspection data for the machine. The processor of the most downstream machine accordingly functions as a supervisory computer having all the data of all the inspection machines.

1. A multi-machine system for inspecting bottles comprising at least one upstream machine and a downstream most machine, wherein each machine performs at least one inspection on a bottle and a bottle is conveyed sequentially through the machines, comprising
a processor for each machine to determine whether a bottle is defective and should be rejected,
an Ethernet cable connection between each upstream processor and the next downstream processor,
said processors of the upstream machines each comprising means for supplying to the Ethernet cable connection between the processor and the next downstream processor, an Ethernet packet including inspection data.
